(19) United States
(12) Patent Application Publication
(10) Pub. No.: US 2018/0115224 A1
(43) Pub. Date: Apr. 26, 2018

(54) MOTOR

(71) Applicant: Nidec Corporation, Kyoto (JP)

(72) Inventor: Yoshiaki YAMASHITA, Kyoto (JP)

(21) Appl. No.: 15/562,971

(22) PCT Filed: Mar. 30, 2016
(86) PCT No.: PCT/JP2016/060289

§ 371 Date: Sep. 29, 2017

(30) Foreign Application Priority Data
Mar. 30, 2015 (JP) 2015-070265

(51) Int. Cl. H02K 11/30; H02K 5/16

(52) U.S. Cl. CPC H02K 11/30; H02K 5/16

(57) ABSTRACT

A motor includes a rotor, stator, upper bearing, lower bearing, housing, and control unit. The upper and lower bearings are positioned below an upper surface of the rotor core in an axial direction. The stator directly faces the control unit. The housing includes a housing cylinder portion surrounding the stator in a circumferential direction and a housing bottom portion positioned on a lower side of the stator in the axial direction. The housing bottom portion includes a bottom plate portion covering a lower side of the stator in the axial direction, an upper bearing holding portion holding the upper bearing, and a lower bearing holding portion holding the lower bearing. The upper bearing holding portion is positioned above the lower surface of the bottom plate portion in the axial direction. The lower bearing holding portion is positioned below an upper surface of the bottom plate portion in the axial direction.

### BACKGROUND OF THE INVENTION

### 1. Field of the Invention

The present invention relates to a motor.

### 2. Description of the Related Art

In the related art, in an electric motor, a shaft is supported, for example, in a cantilever structure (Japanese Unexamined Patent Application Publication No. 2007-209101, and the like).

### SUMMARY OF THE INVENTION

In the above-described electric motor, for example, two bearings supporting the shaft are positioned above a bottom portion. Therefore, a distance from a lower end of the bottom portion to a lower bearing is large and it is difficult to hold the lower bearing at a bearing holding portion. Therefore, it is difficult to assemble the electric motor and there are some cases that productivity of the electric motor cannot be sufficiently improved.

A motor of an aspect of the present invention is made in view of the above-described problem and an object of the present invention is to improve productivity.

### Solution to Problem

A motor of an aspect of the present invention includes a rotor, a stator, an upper bearing and a lower bearing, a housing, and a control unit. The rotor includes a shaft with a center axis extending in an upward and downward direction as a center and a rotor core fixed to the shaft. The stator is positioned on an outside of the rotor in a radial direction. The upper bearing and the lower bearing rotatably support the shaft. The housing holds the stator. The control unit is attached to an upper side of the housing in the axial direction. The upper bearing and the lower bearing are positioned below an upper surface of the rotor core in the axial direction. The stator directly faces the control unit. The housing includes a housing cylinder portion surrounding the stator in a circumferential direction and a housing bottom portion positioned on a lower side of the stator in the axial direction. The housing bottom portion includes a bottom plate portion covering the lower side of the stator in the axial direction, an upper bearing holding portion holding the upper bearing, and a lower bearing holding portion holding the lower bearing. The upper bearing holding portion is positioned above a lower surface of the bottom plate portion in the axial direction. The lower bearing holding portion is positioned below an upper surface of the bottom plate portion in the axial direction.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view illustrating a motor of an embodiment.

FIG. 2 is a sectional view illustrating another example of the motor of the embodiment.

### DETAILED DESCRIPTION OF THE PREFERRED EMBODIMENTS

Hereinafter, a motor according to an embodiment of the present invention will be described with reference to the drawings. The scope of the present invention is not limited to the following embodiments and can be arbitrarily changed within the technical idea of the present invention. In addition, in the following drawings, in order to make each configuration easy to understand, scales, numbers and the like in each structure may be made different from those in an actual structure.

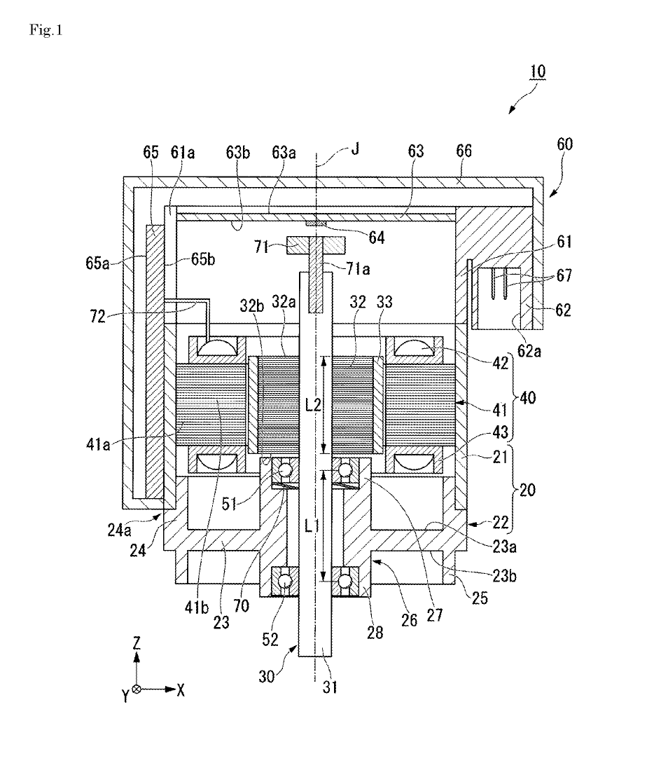

In addition, in the drawings, an XYZ coordinate system is appropriately illustrated as a three-dimensional orthogonal coordinate system. In the XYZ coordinate system, a Z-axis direction is a direction parallel to an axial direction of a center axis J illustrated in FIG. 1. An X-axis direction is a direction orthogonal to the Z-axis direction and is a rightward and leftward direction of FIG. 1. A Y-axis direction is a direction orthogonal to both the X-axis direction and the Z-axis direction.

In the following description, a direction (the Z-axis direction) in which the center axis J extends is an upward and downward direction. A positive side (+Z side) in the Z-axis direction is referred to as an “upper side (upper side in the axial direction)” and a negative side (−Z side) in the Z-axis direction is referred to as a “lower side (lower side in the axial direction)”. Moreover, the upward and downward direction, the upper side, and the lower surface are simply used for explanation and do not limit an actual positional relationship and direction. In addition, unless otherwise specified, a direction (Z axis direction) parallel to the center axis J is simply referred to as an “axial direction”, a radial direction with the center axis J as a center is simply referred to as a “radial direction”, and a circumferential direction with the center axis J as the center is simply referred to as a “circumferential direction”.

FIG. 1 is a sectional view illustrating a motor 10 of the embodiment. As illustrated in FIG. 1, the motor 10 includes a housing 20, a rotor 30, a stator 40, a control unit 60, an upper bearing 51 and a lower bearing 52, a sensor magnet 71, and a preload member 70. The motor 10 is a mechanically and electrically integrated motor.

### [Rotor]

The rotor 30 includes a shaft 31, a rotor core 32, and a rotor magnet 33. The shaft 31 has the center axis J extending in the upward and downward direction as a center. The shaft 31 is supported by the upper bearing 51 and the lower bearing 52 in a cantilever manner. An upper end of the shaft 31 is positioned on an inside of the control unit 60. A lower end of the shaft 31 exposes to the outside of the housing 20 via a shaft inserting portion 26 which is described later.

Moreover, in the present specification, there is provided the shaft that is supported in the cantilever manner and is supported only at a portion positioned farther to one side than the rotor core in the axial direction.

Moreover, in the embodiment, the inside of the control unit 60 includes, for example, a space on an inner side of a substrate case 61 which is described later.

The rotor core 32 is fixed to the shaft 31. In the embodiment, the rotor core 32 is, for example, cylindrical surrounding the shaft 31 in the circumferential direction. The rotor core 32 is, for example, fitted and fixed to an outer peripheral surface of the shaft 31. The rotor magnet 33 is fixed to an outer peripheral surface of the rotor core 32.

### [Sensor Magnet]

The sensor magnet 71 is positioned above the stator 40. The sensor magnet 71 is fixed to the shaft 31. In the embodiment, the sensor magnet 71 is fixed to an upper end of the shaft 31 via a magnet attaching member 71a.

The magnet attaching member 71a is, for example, cylindrical extending in the axial direction. The magnet attaching member 71a is fitted into a hole portion recessed on the lower side provided on an upper end surface of the shaft 31. The sensor magnet 71 is annular. The sensor magnet 71 is fitted into the outer peripheral surface of the magnet attaching member 71a. Therefore, the sensor magnet 71 is fixed to the shaft 31.

### [Stator]

The stator 40 is positioned on the outside of the rotor in the radial direction. The stator 40 is held within the housing 20. The stator 40 directly faces the control unit 60.

Moreover, in the present specification, the stator 40 directly faces the control unit 60 for example, a member partitioning between the stator 40 and the control unit 60 is not provided.

The stator 40 includes a stator core 41, a coil 42, and an insulator 43. The stator core 41 includes a core back portion 41a and a tooth portion 41b. The core back portion 41a is, for example, cylindrical surrounding the shaft 31 in the circumferential direction. The core back portion 41a is fixed to the inner surface of a housing cylinder portion 21 which is described later of the housing 20. The tooth portion 41b extends from the inner surface of the core back portion 41a to the inside in the radial direction. For example, a plurality of the teeth portions 41b are provided. The plurality of the teeth portions 41b are disposed at equal intervals along the circumferential direction.

The coil 42 is wound around the tooth portion 41b via the insulator 43. The insulator 43 is, for example, a bobbin shape. The insulator 43 is mounted on the tooth portion 41b.

### [Control Unit]

The control unit 60 is attached to the upper side of the housing 20. The control unit 60 includes the substrate case 61, a connector portion 62, a control substrate 63, a rotation sensor 64, a power substrate 65, a substrate cover 66, and a connector wiring 67.

The substrate case 61 is cylindrical surrounding the center axis J in the circumferential direction. The substrate case 61 opens on both sides in the axial direction. The substrate case 61 is fixed to an upper end of the housing cylinder portion 21 which is described later of the housing 20. The substrate case includes a substrate case through-hole 61a penetrating the substrate case 61 in the radial direction. The substrate case through-hole 61a is positioned, for example, at an end portion of the substrate case 61 on a power substrate 65 side (−X side).

The connector portion 62 protrudes from the substrate case 61 to the outside in the radial direction. The connector portion 62 is positioned, for example, on a side (+X side) opposite to the power substrate 65 with the center axis J as a reference. The connector portion 62 includes a connector opening portion 62a opening to the lower side. The connector portion 62 is connected to an external power supply (not illustrated).

The control substrate 63 is held on the inside of the substrate case 61. The control substrate 63 is positioned on the upper side of the rotor core 32. Although illustration is omitted, the control substrate 63 is electrically connected to the power substrate 65. A substrate surface of the control substrate 63 is, for example, orthogonal to the center axis J. That is, a control substrate upper surface 63a that is the upper surface of the control substrate 63 and a control substrate lower surface 63b that is the lower surface of the control substrate 63 are, for example, orthogonal to the center axis J. At least one of the control substrate upper surface 63a and the control substrate lower surface 63b is provided with, for example, a print wiring (not illustrated).

The rotation sensor 64 is attached to the control substrate 63. More specifically, the rotation sensor 64 is attached to the control substrate lower surface 63b. The rotation sensor 64 detects a rotation position of the rotor 30. The rotation sensor 64 is, for example, a magneto-resistive element. The rotation sensor 64 faces the sensor magnet 71 in the axial direction. In the embodiment, the rotation sensor 64 and the sensor magnet 71 face each other on the inside of the control unit 60. Therefore, it is possible to close a distance between the rotation sensor 64 and the sensor magnet 71 in the axial direction. Therefore, the detection accuracy of the rotation sensor 64 can be improved.

The power substrate 65 is positioned farther to the outside than the housing 20 in the radial direction. More specifically, the power substrate 65 is fixed to, for example, the outer surface of the housing cylinder portion 21 which is described later. The power substrate 65 is electrically connected to the coil 42 via a connection wiring 72. That is, the power substrate 65 is electrically connected to the stator 40. The connection wiring 72 is connected to the power substrate 65 from the coil 42 via the inside of the substrate case 61 and the substrate case through-hole 61a.

The substrate surface of the power substrate 65 is inclined with respect to the control substrate upper surface 63a and the control substrate lower surface 63b. That is, a power substrate outer surface 65a that is an outer surface of the power substrate 65 in the radial direction and a power substrate inner surface 65b that is an inner surface of the power substrate 65 in the radial direction are inclined with respect to the control substrate upper surface 63a and the control substrate lower surface 63b. Therefore, it is possible to reduce the motor 10 in size in the axial direction while suppressing an increase of the motor 10 in size in the radial direction.

In the embodiment, the power substrate outer surface 65a and the power substrate inner surface 65b are, for example, orthogonal to the control substrate upper surface 63a and the control substrate lower surface 63b. That is, the power substrate outer surface 65a and the power substrate inner surface 65b are parallel to the center axis J. Therefore, an increase of the motor 10 in size in the radial direction is suppressed.

The power substrate 65 includes a switching element (not illustrated). For example, a plurality of the switching elements are provided. The plurality of the switching elements configure an inverter circuit.

The substrate cover 66 covers the upper side of the control substrate 63 and the outside of the power substrate 65 in the radial direction. The substrate cover 66 is attached to, for example, the substrate case 61 and the housing 20.

Although illustration is omitted, the connector wiring 67 is electrically connected to the control substrate 63. One end of the connector wiring 67 is exposed in the connector opening portion 62a of the connector portion 62. The connector wiring 67 electrically connects the external power supply connected to the connector portion 62 and the control substrate 63 to each other. Therefore, a driving current is supplied from the external power supply to the control substrate 63. The driving current is supplied to the rotation sensor 64 and the power substrate 65 via the control substrate 63. The driving current supplied to the power substrate 65 is supplied to the coil 42 via the connection wiring 72.

### [Housing]

The housing 20 holds the stator 40. The housing 20 includes the housing cylinder portion 21 and a housing bottom portion 22. In the embodiment, the housing cylinder portion 21 and the housing bottom portion 22 are separate members. The housing cylinder portion 21 is cylindrical surrounding the stator 40 in the circumferential direction. In the embodiment, the inner surface of the housing cylinder portion 21 is, for example, cylindrical concentric with the shaft 31.

The housing bottom portion 22 is attached to a lower end of the housing cylinder portion 21. The housing bottom portion 22 is positioned on the lower side of the stator 40. The housing bottom portion 22 includes a bottom plate portion 23, an upper wall portion 24, a lower wall portion 25, and the shaft inserting portion 26.

The bottom plate portion 23 covers the lower side of the stator 40. In the embodiment, the bottom plate portion 23 is, for example, annular surrounding the shaft 31 in the circumferential direction. The upper wall portion 24 extends from an outer edge of the outside of the bottom plate portion 23 in the radial direction to the upper side. The lower wall portion 25 extends an outer edge of the outside of the bottom plate portion 23 in the radial direction to the lower side.

The upper wall portion 24 is fitted into the inside of the housing cylinder portion 21 in the radial direction. That is, the upper wall portion 24 and the housing cylinder portion 21 are fitted into each other. Therefore, the housing cylinder portion 21 and the housing bottom portion 22 can be accurately fixed.

A stepped portion 24a is provided on the outer peripheral surface of the upper wall portion 24. The stepped portion 24a is a step in which a diameter of the upper wall portion 24 decreases from the lower side to the upper side. A lower end surface of the housing cylinder portion 21 is in contact with a surface facing the upper side of the stepped portion 24a. Therefore, a relative position between the housing cylinder portion 21 and the housing bottom portion 22 in the axial direction is determined.

The shaft inserting portion 26 is cylindrical extending from an inner edge of the bottom plate portion 23 to the upper side and the lower side. A part of the shaft 31 is inserted into the inside of the shaft inserting portion 26. The shaft inserting portion 26 includes an upper bearing holding portion 27 that holds the upper bearing 51 and a lower bearing holding portion 28 that holds the lower bearing 52. That is, the housing bottom portion 22 includes the upper bearing holding portion 27 and the lower bearing holding portion 28.

The upper bearing holding portion 27 is positioned above than a bottom plate portion lower surface 23b that is the lower surface of the bottom plate portion 23. The lower bearing holding portion 28 is positioned below a bottom plate portion upper surface 23a that is the upper surface of the bottom plate portion 23.

Therefore, it is possible to reduce a distance from the lower end of the housing bottom portion 22 to the lower bearing holding portion 28. Therefore, the lower bearing 52 is easily held to the lower bearing holding portion 28 from the lower side of the housing bottom portion 22. In addition, similarly, it is possible to reduce a distance from the upper end of the housing bottom portion 22 to the upper bearing holding portion 27 so that the upper bearing 51 is easily held to the upper bearing holding portion 27 from the upper side of the housing bottom portion 22. Therefore, the assembling performance of the motor 10 can be improved. As a result, according to the embodiment, the motor 10 having a structure capable of improving productivity is obtained.

In addition, in the embodiment, as described above, the housing cylinder portion 21 and the housing bottom portion 22 are separate members. The upper bearing 51 and the lower bearing 52 can be held by the upper bearing holding portion 27 and the lower bearing holding portion 28 before the housing bottom portion 22 is attached to the housing cylinder portion 21. Therefore, the upper bearing 51 and the lower bearing 52 are further easily held by the upper bearing holding portion 27 and the lower bearing holding portion 28. Therefore, according to the embodiment, the productivity of the motor 10 can be further improved.

In addition, according to the embodiment, for example, in a case where a dimension of the stator 40 in the axial direction is changed, or in a case where an error occurs in a dimension of the stator 40 in the axial direction, the housing 20 can be adjusted to the dimension of the stator 40 in the axial direction by exchanging only the housing bottom portion 22. Therefore, it is convenient to change the configuration of the housing 20 with respect to the change of the dimension of the stator 40 in the axial direction.

In the embodiment, the upper bearing holding portion 27 is positioned above the bottom plate portion upper surface 23a. In the embodiment, the lower bearing holding portion 28 is positioned below the bottom plate portion lower surface 23b. Therefore, a distance between the upper end of the housing bottom portion 22 and the upper bearing holding portion 27, and a distance between the lower end of the housing bottom portion 22 and the lower bearing holding portion 28 can be further reduced. Therefore, the upper bearing 51 and the lower bearing 52 are further easily held by the upper bearing holding portion 27 and the lower bearing holding portion 28. Therefore, according to the embodiment, the productivity of the motor 10 can be further improved.

The upper bearing holding portion 27 is cylindrical opening to the upper surface of the shaft inserting portion 26. That is, in the embodiment, the upper bearing holding portion 27 is provided at an end portion on the upper side of the shaft inserting portion 26. The lower bearing holding portion 28 is cylindrical opening to the lower surface of the shaft inserting portion 26. That is, in the embodiment, the lower bearing holding portion 28 is provided at an end portion on the lower side of the shaft inserting portion 26.

Therefore, a distance between the upper end of the housing bottom portion 22 and the upper bearing holding portion 27, and a distance between the lower end of the housing bottom portion 22 and the lower bearing holding portion 28 can be further reduced. Therefore, according to the embodiment, the productivity of the motor 10 can be further improved.

In addition, according to the embodiment, one shaft inserting portion 26 is provided with two bearing holding portions, that is, the upper bearing holding portion 27 and the lower bearing holding portion 28. Therefore, a relative positional accuracy between the upper bearing holding portion 27 and the lower bearing holding portion 28 in the radial direction is easily improved. Therefore, the positions of the upper bearing 51 and the lower bearing 52 in the radial direction are easily aligned and inclination of the shaft 31 can be suppressed.

In addition, since the shaft inserting portion 26 extends from the inner edge of the bottom plate portion 23 to the upper side and the lower side, the shaft inserting portion 26 is easily supported by the bottom plate portion 23 in the vicinity of the center in the axial direction. Therefore, the rigidity of the shaft inserting portion 26 is easily increased. As a result, the upper bearing 51 and the lower bearing 52 can be stably held by the upper bearing holding portion 27 and the lower bearing holding portion 28.

The end portion on the upper side of the upper bearing holding portion 27 is positioned above the upper wall portion 24. Therefore, when the upper bearing 51 is held by the upper bearing holding portion 27, the upper wall portion 24 does not become an obstacle. Therefore, the upper bearing 51 is further easily held by the upper bearing holding portion 27. In addition, since the upper bearing holding portion 27 can be positioned at the upper end of the housing bottom portion 22, the upper bearing 51 is further easily held by the upper bearing holding portion 27. Therefore, according to the embodiment, the productivity of the motor 10 can be further improved.

The end portion on the lower side of the lower bearing holding portion 28 is positioned below the lower wall portion 25. Therefore, when the lower bearing 52 is held by the lower bearing holding portion 28, the lower wall portion 25 does not become an obstacle. Therefore, the lower bearing 52 is easily held by the lower bearing holding portion 28. In addition, since the lower bearing holding portion 28 can be positioned at the lower end of the housing bottom portion 22, the lower bearing 52 is further easily held by the lower bearing holding portion 28. Therefore, according to the embodiment, the productivity of the motor 10 can be further improved.

In the embodiment, the upper bearing holding portion 27 is positioned at the upper end of the housing bottom portion 22. The upper bearing holding portion 27 is positioned, for example, below a rotor core lower surface 32b. A part of the upper bearing holding portion 27 overlaps the insulator 43 in the radial direction. Therefore, a space within the housing 20 can be effectively utilized and the motor 10 is reduced in size. In the embodiment, the lower bearing holding portion 28 is positioned at the lower end of the housing bottom portion 22.

In the embodiment, the bottom plate portion 23 and the shaft inserting portion 26 are a single member. That is, the bottom plate portion 23, the upper bearing holding portion 27, and the lower bearing holding portion 28 are a single member. Therefore, the number of components of the motor 10 can be reduced. Therefore, the number of assembling steps of the motor 10 can be reduced and the productivity of the motor 10 can be improved. In addition, a manufacturing cost of the motor 10 can be reduced. In addition, the rigidity of the upper bearing holding portion 27 and the rigidity of the lower bearing holding portion 28 are easily increased. Therefore, vibration of the upper bearing holding portion 27 and the lower bearing holding portion 28 by the rotation of the rotor 30 can be suppressed.

### [Upper Bearing and Lower Bearing]

The upper bearing 51 and the lower bearing 52 support the shaft 31 to be rotatable around the center axis J. The upper bearing 51 is held by the upper bearing holding portion 27. The lower bearing 52 is held by the lower bearing holding portion 28. The upper bearing 51 and the lower bearing 52 are positioned below a rotor core upper surface 32a that is the upper surface of the rotor core 32.

Therefore, in the embodiment, the shaft 31 is supported by the upper bearing 51 and the lower bearing 52 in a cantilever manner, and it is not necessary to dispose the bearing supporting the shaft 31, above the stator 40. Therefore, it is not necessary to provide the bearing holder that holds the bearing, between the stator 40 and the control unit 60.

For example, in a case where the bearing holder is provided between the stator 40 and the control unit 60, a space between the control unit 60 and the stator 40 becomes narrow. Therefore, the degree of difficulty of connection wiring connecting the stator 40 and the control unit 60 is high. In addition, the wiring connecting the stator 40 and the control unit 60 are necessary to be disposed to penetrate the bearing holder in the axial direction so that the structure of the motor is likely to be complicated. Therefore, it is difficult to assemble the motor and there is a concern that the productivity of the motor is decreased.

On the other hand, according to the embodiment, since there is unnecessary to provide the bearing holder between the stator 40 and the control unit 60, it is possible to cause the stator 40 and the control unit 60 to directly face each other. Therefore, the stator 40 and the control unit 60 are easily electrically connected to each other. Specifically, for example, the connection wiring 72 electrically connecting the stator 40 and the control unit 60 to each other is easily disposed. Therefore, the productivity of the motor 10 can be improved.

Since it is unnecessary to provide the bearing holder between the stator 40 and the control unit 60, an increase of the motor 10 in size in the axial direction can be suppressed. In addition, since the number of the components of the motor 10 is small, the number of assembling steps and the manufacturing cost of the motor 10 can be reduced.

In the embodiment, the upper bearing 51 and the lower bearing 52 are positioned, for example, below the rotor core lower surface 32b that is the lower surface of the rotor core 32. A distance L1 between the upper bearing 51 and the lower bearing 52 in the axial direction is equal to or more than a dimension L2 of the rotor core 32 in the axial direction.

Therefore, according to the embodiment, the distance L1 is easily increased. Therefore, the shaft 31 is easily and stably held by the upper bearing 51 and the lower bearing 52. As a result, it is possible to suppress axial deflection of the shaft 31. Particularly, as in the embodiment, in a case where the sensor magnet 71 is fixed to the shaft 31, it is possible to suppress axial deflection of the sensor magnet 71. Therefore, lowering of the detection accuracy of the rotation sensor 64 can be suppressed.

In the embodiment, the distance L1 between the upper bearing 51 and the lower bearing 52 in the axial direction is a distance in the axial direction between the center of the upper bearing 51 in the axial direction and the center of the lower bearing 52 in the axial direction.

In the embodiment, the upper end of the upper bearing 51 overlaps the stator 40 in the radial direction. Therefore, an increase of the motor 10 in size in the axial direction can be suppressed while increasing the distance L1 by causing the position of the upper bearing 51 in the axial direction to be on further the upper side. In the embodiment, the upper end of the upper bearing 51 overlaps, for example, the insulator 43 in the radial direction.

In the embodiment, a diameter of the upper bearing 51 is, for example, the same as a diameter of the lower bearing 52. Therefore, bearings of the same type and of the same size can be adopted as the upper bearing 51 and the lower bearing 52. Therefore, it is possible to reduce the number of types of components configuring the motor 10. In the embodiment, the type of the upper bearing 51 and the type of the lower bearing 52 are, for example, the same. In addition, each dimension of the upper bearing 51 and each dimension of the lower bearing 52 are, for example, the same.

### [Preload Member]

The preload member 70 is positioned on the inside of the upper bearing holding portion 27 in the radial direction. The preload member 70 is positioned on the lower side of the upper bearing 51. The preload member 70 applies a pressure of the upper side to the upper bearing 51. That is, the preload member 70 applies a pressure in the axial direction to the upper bearing 51. Therefore, vibration of the upper bearing 51 in the axial direction can be suppressed and abnormal noises caused by the vibration of the upper bearing 51 can be suppressed.

The configuration of the preload member 70 is not particularly limited as long as the pressure in the axial direction can be applied to the upper bearing 51. The preload member 70 is, for example, a wave washer.

In the mechanically and electrically integrated motor, such as the motor 10 of the above-described embodiment, the control unit is mounted together with the driving portion of the motor, for example, the rotor and the stator. In this case, the number of assembling steps of the motor tends to increase. Specifically, for example, a step of installing the control unit, a step of connecting the power substrate of the control unit and the stator by connection wiring, a step of connecting the power substrate and the control substrate, and the like are required. Therefore, as described above, in a case where the bearing holder is provided, the degree of difficulty of connecting the control unit and the stator is high. Therefore, the productivity of the motor is likely to be decreased. Therefore, in the embodiment, the effect of improving the productivity of the motor 10 is particularly effective in the mechanically and electrically integrated motor.

As described above, since the control unit 60 and the stator 40 can be easily connected by supporting the shaft 31 in a cantilever manner, the productivity of the mechanically and electrically integrated motor 10 can be improved and the manufacturing cost of the motor 10 can be reduced. In a case where the shaft 31 is supported in a cantilever manner, the shaft 31 can be supported more stably as the motor is reduced in size. However, on the other hand, as the motor is reduced in size, it becomes more difficult to hold the upper bearing 51 and the lower bearing 52 by the upper bearing holding portion 27 and the lower bearing holding portion 28, and the productivity of the motor is likely to be decreased.

On the other hand, in the motor 10 of the embodiment, the upper bearing 51 and the lower bearing 52, which support the shaft 31 in a cantilever manner, are easily held by the upper bearing holding portion 27 and the lower bearing holding portion 28. Therefore, the shaft 31 can be supported more stably and the decrease in the productivity of the motor 10 can be suppressed by reducing the motor 10 in size. As described above, the structure of the motor 10 of the embodiment is a particularly useful for reducing the mechanically and electrically integrated motor in size.

In the embodiment, the following configurations can be adopted.

In the embodiment, the upper bearing 51 may be positioned above the rotor core lower surface 32b as long as it is below the rotor core upper surface 32a. In this case, the rotor core lower surface 32b is provided with, for example, a hole portion recessed on the upper side. At least a part of the upper bearing 51 is positioned on an inside of the hole portion provided on the rotor core lower surface 32b.

In the embodiment, at least a part of the upper bearing holding portion 27 may be positioned below the bottom plate portion upper surface 23a as long as it is above the bottom plate portion lower surface 23b. In addition, in the embodiment, at least a part of the lower bearing holding portion 28 may be positioned above the bottom plate portion lower surface 23b as long as it is below the bottom plate portion upper surface 23a.

In the embodiment, the bottom plate portion 23 and the shaft inserting portion 26 may be separate members. In addition, in the embodiment, the upper bearing holding portion 27 and the lower bearing holding portion 28 may be separate members. In this case, for example, the shaft inserting portion 26 may be configured of the upper bearing holding portion 27 and the lower bearing holding portion 28 which are separate members respectively, and a portion connecting the upper bearing holding portion 27 and the lower bearing holding portion 28.

In the embodiment, at least a part of the upper bearing 51 can adopt a configuration in which at least a part of the upper bearing 51 overlaps the stator 40 in the radial direction. That is, in the embodiment, the entirety of the upper bearing 51 may overlap the stator 40 in the radial direction.

In the embodiment, the preload member 70 may be positioned on the upper side of the upper bearing 51. In this case, the preload member 70 applies a pressure of the lower side to the upper bearing 51.

In the embodiment, the diameter of the upper bearing 51 and the diameter of the lower bearing 52 may be different. In addition, in the embodiment, the type of the upper bearing 51 and the type of the lower bearing 52 may be different. In this case, for example, the lower bearing 52 may be a highly waterproof bearing. In addition, in the embodiment, each dimension of the upper bearing 51 and each dimension of the lower bearing 52 may be partially different.

In the embodiment, the control unit 60 may have only one substrate. In this case, for example, one substrate has a function of the control substrate 63 and a function of the power substrate 65.

In the embodiment, the rotation sensor 64 may be, for example, a Hall element or a resolver. In addition, in the embodiment, a plurality of the rotation sensors 64 may be provided.

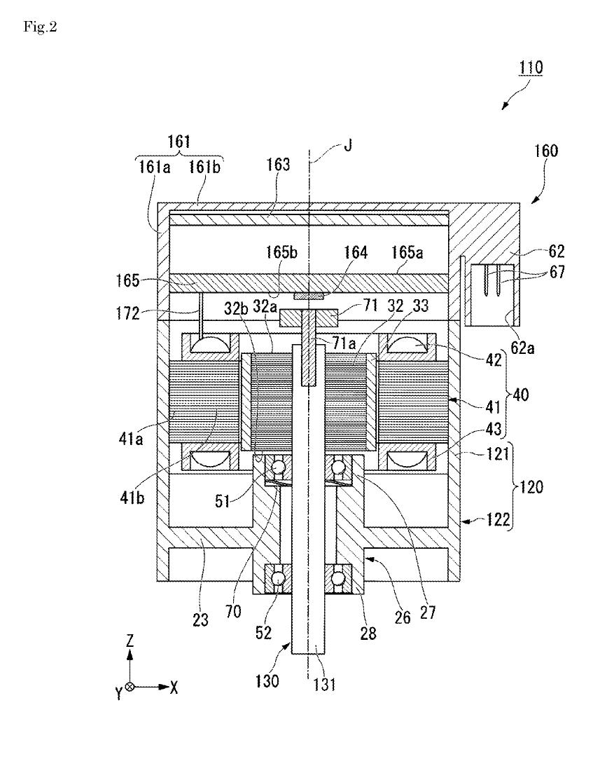

In the embodiment, a configuration illustrated in FIG. 2 may be adopted. FIG. 2 is a sectional view illustrating a motor 110 that is another example of the embodiment. Moreover, in the following description, the configurations similar to the above description are sometimes omitted by appropriately denoting the same reference numerals or the like.

As illustrated in FIG. 2, the motor 110 includes a housing 120, a rotor 130, a stator 40, a control unit 160, an upper bearing 51 and a lower bearing 52, a sensor magnet 71, and a preload member 70.

The rotor 130 includes a shaft 131, a rotor core 32, and a rotor magnet 33. The shaft 131 is similar to the shaft 31 illustrated in FIG. 1 except that the dimension in the axial direction is small.

The control unit 160 includes a substrate case 161, a connector portion 62, a control substrate 163, a rotation sensor 164, a power substrate 165, and a connector wiring 67. The substrate case 161 includes a substrate case cylinder portion 161a and a substrate case top plate portion 161b.

The substrate case cylinder portion 161a is cylindrical surrounding the center axis J in the circumferential direction. The substrate case cylinder portion 161a opens to the lower side. The substrate case cylinder portion 161a is fixed to an upper end of the housing 120. The substrate case top plate portion 161b is connected to an upper end of the substrate case cylinder portion 161a. The substrate case top plate portion 161b covers an upper side of the control substrate 163.

The control substrate 163 is similar to the control substrate 63 illustrated in FIG. 1 except that the rotation sensor 164 is not attached. The rotation sensor 164 is attached to the power substrate 165. More specifically, the rotation sensor 164 is attached to a power substrate lower surface 165b that is a lower surface of the power substrate 165. Other configurations of the rotation sensor 164 are similar to the configurations of the rotation sensor 64 illustrated in FIG. 1.

The power substrate 165 is held on the inside of the substrate case cylinder portion 161a. The power substrate 165 is positioned on the lower side of the control substrate 163. Therefore, the control substrate 163 and the power substrate 165 can be disposed to overlap in the axial direction. Therefore, according to the embodiment, the motor 110 can be reduced in size in the radial direction.

In the embodiment, a substrate surface of the power substrate 165 is orthogonal to the center axis J. That is, the power substrate lower surface 165b and a power substrate upper surface 165a that is the upper surface of the power substrate 165 are, for example, orthogonal to the center axis J. Therefore, the control substrate 163 and the power substrate 165 close to each other in the axial direction. Therefore, an increase of the motor 110 in size in the axial direction can be suppressed.

The power substrate 165 is electrically connected to the coil 42 by a wiring member 172. Other configurations of the power substrate 165 are similar to the configurations of the power substrate 65 illustrated in FIG. 1.

The housing 120 includes a housing cylinder portion 121 and a housing bottom portion 122. In the embodiment, the housing 120 is a single member. That is, in the embodiment, the housing cylinder portion 121 and the housing bottom portion 122 are a single member.

Therefore, the number of components of the motor 110 can be reduced. In addition, the housing cylinder portion 121 and the housing bottom portion 122 are strongly connected as compared to a case where the housing cylinder portion 121 and the housing bottom portion 122 are separate members. Therefore, for example, vibration of the housing bottom portion 122 by the rotation of the rotor 30 can be suppressed. As a result, vibration of the upper bearing holding portion 27 and the lower bearing holding portion 28 can be suppressed.

Other configurations of the housing cylinder portion 121 are similar to the configurations of the housing cylinder portion illustrated in FIG. 1. Other configurations of the housing bottom portion 122 are similar to the configurations of the housing bottom portion 22 illustrated in FIG. 1. Other configurations of the motor 110 are similar to the configurations of the motor 10 illustrated in FIG. 1.

Moreover, each of the above-described configurations can be appropriately combined within a range not inconsistent with each other.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A motor comprising:
a rotor that has a shaft with a center axis extending in an upward and downward direction as a center and a rotor core fixed to the shaft;
a stator positioned on an outside of the rotor in a radial direction;
an upper bearing and a lower bearing which rotatably support the shaft;
a housing holding the stator; and
a control unit attached to an upper side of the housing in an axial direction,
wherein the upper bearing and the lower bearing are positioned below an upper surface of the rotor core in the axial direction,
wherein the stator directly faces the control unit,
wherein the housing includes a housing cylinder portion surrounding the stator in a circumferential direction and a housing bottom portion positioned on a lower side of the stator in the axial direction,
wherein the housing bottom portion includes a bottom plate portion covering the lower side of the stator in the axial direction, an upper bearing holding portion holding the upper bearing, and a lower bearing holding portion holding the lower bearing,
wherein the upper bearing holding portion is positioned above a lower surface of the bottom plate portion in the axial direction, and
wherein the lower bearing holding portion is positioned below an upper surface of the bottom plate portion in the axial direction.

2. The motor according to claim 1,
wherein the upper bearing holding portion is positioned above the upper surface of the bottom plate portion in the axial direction, and
wherein the lower bearing holding portion is positioned below the lower surface of the bottom plate portion in the axial direction.

3. The motor according to claim 1,
wherein the housing cylinder portion and the housing bottom portion are separate members.

4. The motor according to claim 3,
wherein the housing bottom portion includes an upper wall portion extending to the upper side in the axial direction from an outer edge on the outside of the bottom plate portion in the radial direction, and
wherein the upper wall portion and the housing cylinder portion are fitted to each other.

5. The motor according to claim 3,
wherein the housing bottom portion includes an upper wall portion extending to the upper side in the axial direction from an outer edge of the outside of the bottom plate portion in the radial direction, and
wherein an end portion of the upper side of the upper bearing holding portion in the axial direction is positioned above the upper wall portion in the axial direction.

6. The motor according to claim 3,
wherein the bottom plate portion, the upper bearing holding portion, and the lower bearing holding portion are a single member.

7. The motor according to claim 1,
wherein the housing cylinder portion and the housing bottom portion are a single member.

8. The motor according to claim 1,
wherein the bottom plate portion has an annular shape surrounding the shaft in the circumferential direction,
wherein the housing bottom portion includes a cylindrical shaft inserting portion extending from an inner edge of the bottom plate portion to the upper side and the lower side,
wherein an end portion of an upper side of the shaft inserting portion in the axial direction is provided with the upper bearing holding portion, and
wherein an end portion of a lower side of the shaft inserting portion in the axial direction is provided with the lower bearing holding portion.

9. The motor according to claim 1,
wherein a distance between the upper bearing and the lower bearing in the axial direction is equal to or more than a dimension of the rotor core in the axial direction.

10. The motor according to claim 1,
wherein at least a part of the upper bearing overlaps the stator in the radial direction.

11. The motor according to claim 1, further comprising:
a sensor magnet that is positioned above the stator in the axial direction and is fixed to the shaft,
wherein the control unit includes a rotation sensor detecting a rotation position of the rotor, and
wherein the rotation sensor and the sensor magnet face each other on an inside of the control unit.

12. The motor according to claim 1,
wherein a diameter of the upper bearing is the same as a diameter of the lower bearing.

13. The motor according to claim 1, further comprising:
a preload member applying a pressure in the axial direction to the upper bearing.

14. The motor according to claim 1,
wherein the control unit includes a power substrate electrically connected to the stator and a control substrate electrically connected to the power substrate,
wherein the control substrate is positioned on the upper side of the rotor core in the axial direction,
wherein the power substrate is positioned on an outside of the housing in the radial direction, and
wherein a substrate surface of the power substrate is inclined with respect to a substrate surface of the control substrate.

15. The motor according to claim 1,
wherein the control unit includes a power substrate electrically connected to the stator and a control substrate electrically connected to the power substrate,
wherein the control substrate is positioned on the upper side of the rotor core in the axial direction, and
wherein the power substrate is positioned on the lower side of the control substrate in the axial direction.
